(19) United States
(12) Patent Application Publication
(10) Pub. No.: US 2013/0149022 A1
(43) Pub. Date: Jun. 13, 2013

(54) GREASE APPLICATION APPARATUS AND METHOD FOR HEAT SINK

(71) Applicants: WEI-MIN QIN, Wuhan City (CN); YONG MA, Wuhan City (CN); WEI LIANG, Wuhan City (CN); YU-LIN LIU, Wuhan City (CN)

(72) Inventors: WEI-MIN QIN, Wuhan City (CN); YONG MA, Wuhan City (CN); WEI LIANG, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/585,195

(22) Filed: Aug. 14, 2012

(30) Foreign Application Priority Data
Dec. 12, 2011 (CN) 201110411742.X

(51) Int. Cl. B43K 29/00

(52) U.S. Cl. 401/195

(57) ABSTRACT

A smearing apparatus includes a supporting tray, a rotating cabinet rotatably attached to the supporting tray, and an operating member rotatably attached to the supporting tray. The supporting tray includes a smearing piece. The rotating cabinet is used to receive a heat sink. The operating member is engaged with the rotating cabinet and rotatable about a first axis to rotate the rotating cabinet about a second axis that is substantially perpendicular to the first axis, so that a center portion of the heat sink is smeared by the smearing piece.

### BACKGROUND

1. Technical Field

The present disclosure relates to grease application apparatuses and methods, more particularly to a thermal grease application apparatus and method for a heat sink.

2. Description of Related Art

A heat sink performs a critical function of removing heat from a computer system. The heat sink includes a center portion abutting on a CPU. Thermal grease can be attached to the center portion, so that the efficiency of the heat sink for absorbing the heat generated from the CPU would be increased. Usually, the thermal grease is manually attached to the center portion, which is laborious and time consuming, and the thermal grease cannot evenly attach to the center portion. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a grease application apparatus and a heat sink in accordance with an embodiment.

FIG. 2 is an exploded, isometric view of the grease application apparatus of FIG. 1.

FIG. 3 is similar to FIG. 2, but viewed from a different aspect.

FIG. 4 is an assembled view of FIG. 1.

FIG. 5 is similar to FIG. 4, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

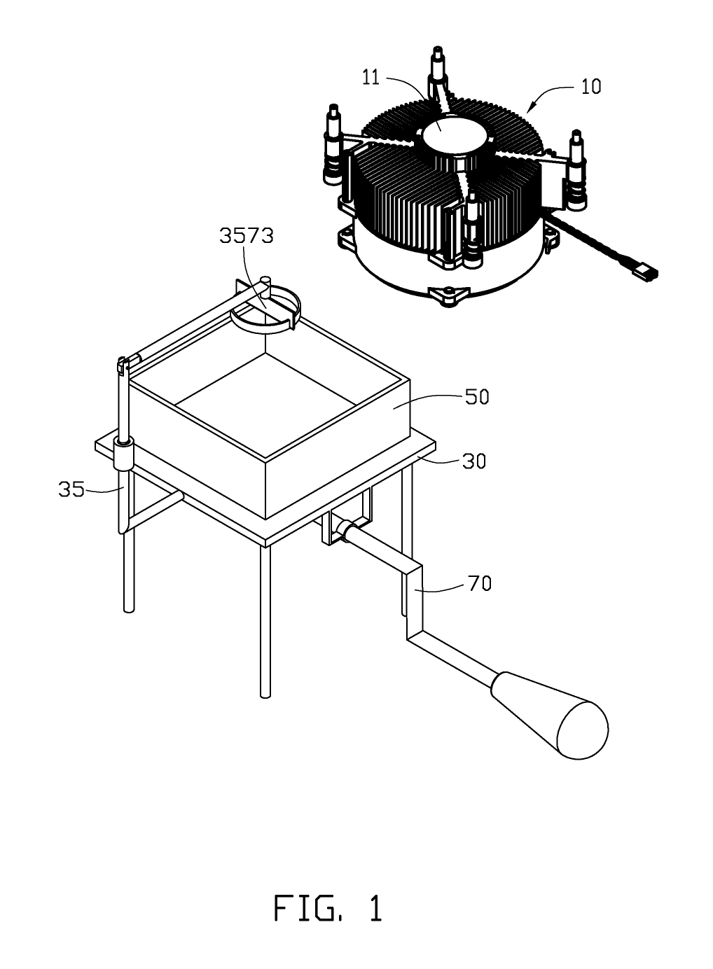

FIG. 1 illustrates a grease application apparatus in accordance with an embodiment for application a thermal grease on a heat sink 10. The smearing apparatus includes a supporting tray 30, a rotating cabinet 50 rotatably attached to the supporting tray 30, and an operating member 70 rotatably attached to the supporting tray 30. The heat sink 10 includes a center portion 11 for receiving the thermal grease.

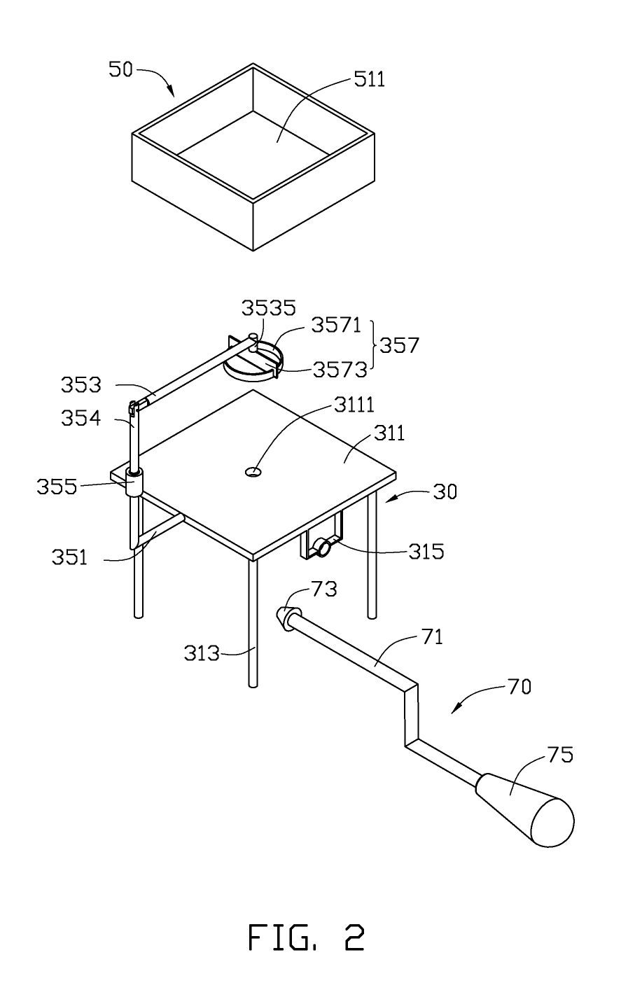

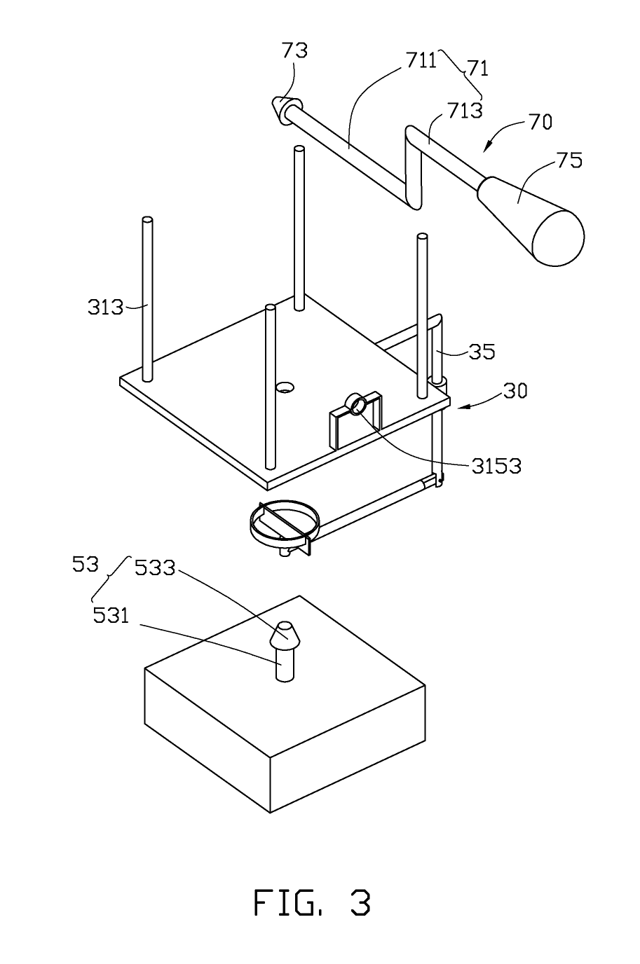

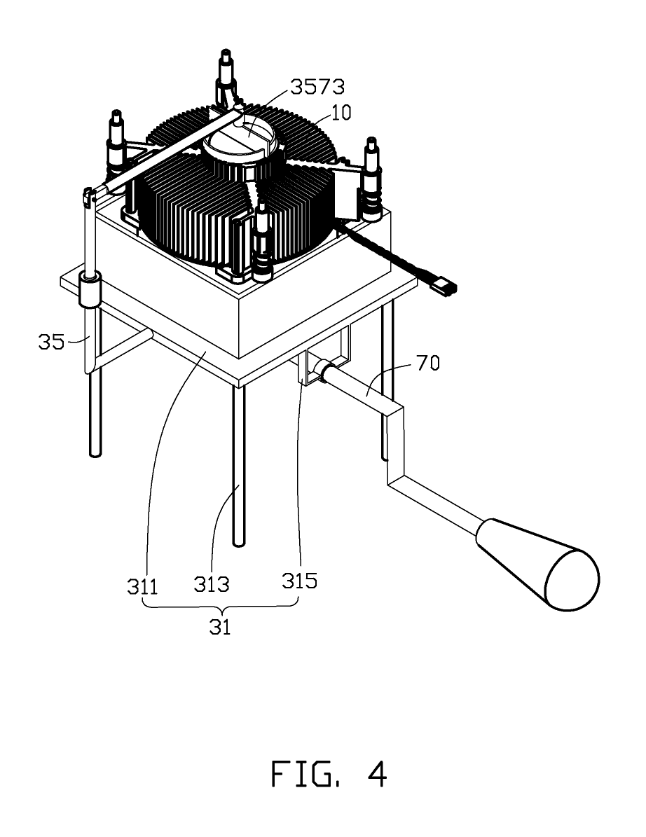

FIGS. 2 and 3 illustrate the supporting tray 30 and the rotating cabinet 50 of the smearing apparatus in accordance with an embodiment. The supporting tray 30 includes a main body 31 (see FIG. 4) and an adjusting member 35 secured to the main body 31.

The main body 31 includes a supporting platform 311, four feet 313 extending from the supporting platform 311, and a securing member 315 attached to the supporting platform 311. A first pivoting hole 3111 is defined in the center of the supporting platform 311. The securing member 315 defines a securing hole 3153. In one embodiment, the securing member 315 is U-shaped.

The adjusting member 35 includes a connecting post 351 connected to the supporting platform 311, an extending post 353, an adjusting post 354, and a smearing portion 357 connected to the extending post 353. The adjusting post 354 is connected to the connecting post 351 and the extending post 353. In one embodiment, the connecting post 351 is substantially perpendicular to the supporting platform 311, and the adjusting post 354 is substantially perpendicular to the connecting post 351 and the extending post 353. An extending direction of the extending post 353 is substantially parallel to the supporting platform 311. An adjusting member 355 is secured to the adjusting post 354. A linking post 3535 extends from the extending post 353 and connected to the smearing portion 357. The linking post 3535 is substantially perpendicular to the extending post 353. In one embodiment, a distance between the linking post 3535 and the adjusting post 354 is substantially equal to that between the first pivoting hole 3111 and the adjusting post 354. The smearing portion 357 includes a receiving portion 3571 for receiving thermal grease and a smearing piece 3573 attached to the receiving portion 3571. In one embodiment, a cross-section of the receiving portion 3571 is circular, and the smearing piece 3573 extends through the center of the circle. The linking post 3535 is secured to a top edge of the smearing piece 3573 and located in the center of the top edge of the smearing piece 3573.

The rotating cabinet 50 includes a receiving space 511 for receiving the heat sink 10 and a mounting member 53 extending from a bottom surface of the rotating cabinet 50. The mounting member 53 includes a mounting post 531 and a first pivoting portion 533 connected to the distal end of the mounting post 531. In one embodiment, the first pivoting portion 533 is a cone-shaped gear.

The operating member 70 includes a rotating shaft 71, a second pivoting portion 73 extending from a first end of the rotating shaft 71, and a handle 75 extending from a second end of the rotating shaft 71. The rotating shaft 71 includes a rotating portion 711 and a driving portion 713 connected to the rotating portion 711. In one embodiment, the driving portion 713 is L-shaped, and the second pivoting portion 73 is a cone-shaped gear.

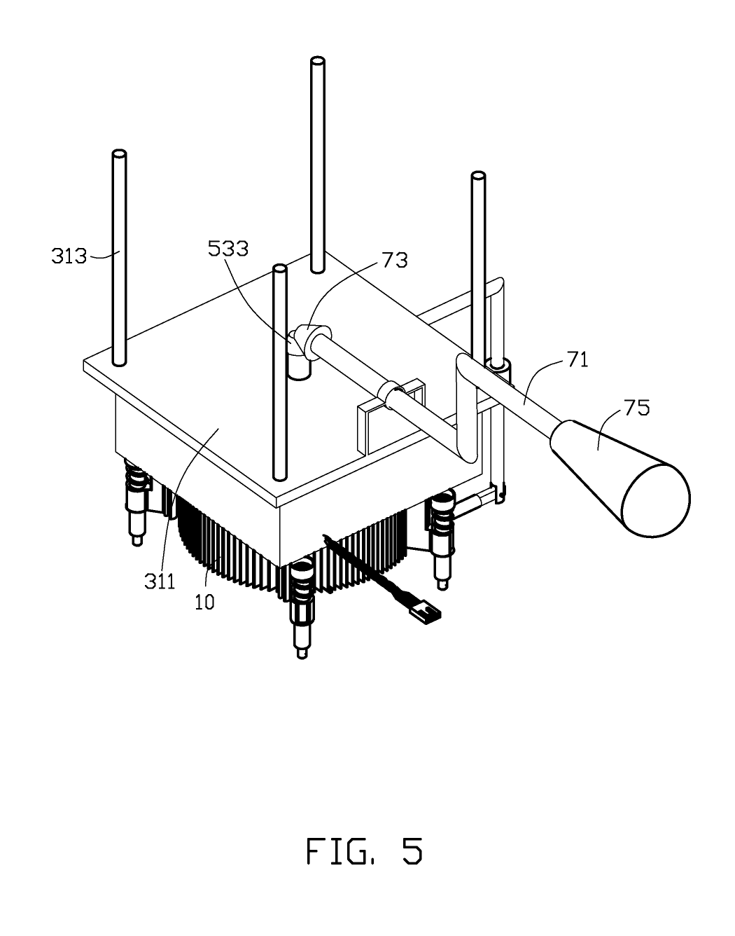

FIGS. 4-5 illustrate the assembly of the grease application apparatus in accordance with an embodiment. In assembly, the mounting post 531 extends through the first pivoting hole 3111 from a top surface of the supporting platform 311 to a bottom surface of the supporting platform 311. The first pivoting portion 533 is secured to the distal end of the mounting post 531, for preventing the mounting post 531 from disengaging from the first pivoting hole 3111. The rotating shaft 71 extends from the securing hole 3153 to rotatably secure the rotating shaft 71 to the securing member 315. At this point, the second pivoting portion 73 abuts the first pivoting portion 533. The heat sink 10 is received in the receiving space 511 to secure the heat sink 10 to the rotating cabinet 50.

In use, the adjusting member 355 is adjusted in a direction substantially perpendicular to the supporting platform 311 to adjust a length of the adjusting post 354, so that a distance between the extending post 353 and the supporting platform 311 can be adjusted. The receiving portion 3571 is positioned above the center portion 11, and the smearing portion 357 abuts the center portion 11. The handle 75 is operated to rotate the rotating shaft 71 in a first axis, which is substantially parallel to the supporting platform 311. Thus, when the rotating shaft 71 is rotated, the first pivoting portion 533 is rotated by the second pivoting portion 73, and the rotating cabinet 50 is rotated in a second axis substantially perpendicular to the supporting platform 311. Therefore, when the rotating cabinet 50 is rotated, the heat sink 10 is rotated, and the smearing piece 3573 can smear the thermal grease in the receiving portion 3571 on the center portion 11.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An apparatus comprising:
a supporting tray comprising a smearing piece;
a rotating cabinet rotatably attached to the supporting tray; the rotating cabinet adapted to receive a heat sink; and
an operating member rotatably attached to the supporting tray and engaged with the rotating cabinet;
wherein the operating member is rotatable about a first axis to rotate the rotating cabinet about a second axis that is substantially perpendicular to the first axis.

2. The apparatus of claim 1, wherein the supporting tray further comprises an extending post and a smearing portion located on a distal end of the extending post, the smearing portion comprises a receiving portion for receiving the thermal grease, and the smearing piece is located in the receiving portion.

3. The apparatus of claim 2, wherein the supporting tray further comprises an adjusting post connected to the extending post; and an adjusting member, located on the adjusting post, is configured for adjusting a length of the adjusting post.

4. The apparatus of claim 3, wherein the adjusting post is substantially perpendicular to the extending post.

5. The apparatus of claim 1, wherein the supporting tray comprises a supporting platform to support the rotating cabinet, and the first axis is substantially parallel to the supporting platform.

6. The apparatus of claim 5, wherein the rotating cabinet comprises a mounting member extending from a bottom surface of the rotating cabinet, the mounting member comprises a mounting post and a first pivoting portion, the mounting post extends through the supporting platform, and the first pivoting portion is attached to the mounting post for preventing the mounting post from disengaging from the supporting platform.

7. The apparatus of claim 6, wherein the operating member comprises a second pivoting portion, and the second pivoting portion abuts the first pivoting portion.

8. The apparatus of claim 7, wherein the operating member further comprises a rotating shaft and a handle, the second pivoting portion extends from a first end of the rotating shaft, and the handle extends from a second end of the rotating shaft.

9. The apparatus of claim 8, wherein the supporting tray further comprises a securing member extending from the supporting platform, and the rotating shaft comprises a rotating portion rotatably attached to the securing member.

10. The apparatus of claim 9, wherein the rotating shaft further comprises a driving portion connected to the rotating portion, and the driving portion is L-shaped.

11. An apparatus comprising:
a supporting tray comprising a supporting platform and a smearing piece above the supporting platform;
a rotating cabinet rotatably attached to the supporting platform and comprising a first pivoting portion; the rotating cabinet adapted to receive a heat sink; and
an operating member rotatably attached to the supporting tray and comprising a second pivoting portion abutting the first pivoting portion;
wherein the operating member is rotatable about a first axis substantially parallel to the supporting platform to rotate the rotating cabinet about a second axis that is substantially perpendicular to the first axis.

12. The apparatus of claim 11, wherein the supporting tray further comprises an extending post and a smearing portion located on a distal end of the extending post, the smearing portion comprises a receiving portion for receiving the thermal grease, and the smearing piece is located in the receiving portion.

13. The apparatus of claim 12, wherein a cross-section of the receiving portion is a circle, and the smearing piece extends through the center of the circle.

14. The apparatus of claim 12, wherein the supporting tray further comprises an adjusting post connected to the extending post; an adjusting member, located on the adjusting post, is configured for adjusting a length of the adjusting post, so that a distance between the extending post and the supporting platform is adjusted.

15. The apparatus of claim 14, wherein the adjusting post is substantially perpendicular to the extending post.

16. The apparatus of claim 14, wherein the supporting tray further comprises a connecting post extending from the supporting platform and connected to the adjusting post, and the connecting post is substantially parallel to the extending post.

17. The apparatus of claim 16, wherein the rotating cabinet comprises a mounting member extending from a bottom surface of the rotating cabinet, the mounting member comprises a mounting post extends through the supporting platform, and the first pivoting portion is attached to the mounting post for preventing the mounting post from disengaging from the supporting platform.

18. The apparatus of claim 17, wherein the operating member further comprises a rotating shaft and a handle, the second pivoting portion extends from a first end of the rotating shaft, and the handle extends from a second end of the rotating shaft.

19. The apparatus of claim 18, wherein the supporting tray further comprises a securing member extending from the supporting platform, and the rotating shaft comprises a rotating portion rotatably attached to the securing member.

20. A method comprising:
rotating an operating member about a first axis;
rotating a rotating cabinet about a second axis substantially perpendicular to the first axis by the operating member;
rotating a heat sink in the rotating cabinet about the second axis; and
smearing the heat sink by a smearing piece of a supporting tray.
